(19) United States
(12) Patent Application Publication
(10) Pub. No.: US 2004/0180713 A1
(43) Pub. Date: Sep. 16, 2004

(54) Game arrangement

(76) Inventor: Gert Eklund, Goteborg (SE)

Correspondence Address: OPPEDAHL AND LARSON LLP, P O BOX 5068, DILLON, CO, 80435-5068, US

(21) Appl. No.: 10/490,755

(22) PCT Filed: Jan. 23, 2002
(86) PCT No.: PCT/US02/01761

(30) Foreign Application Priority Data
Sep. 26, 2001 (SE) 0103194-7

(51) Int. Cl. A63F 13/00

(52) U.S. Cl. 463/17

(57) ABSTRACT

Gaming arrangement comprising a set of lottery tickets divided according to a number series with a particular number of digits placed in the same number of distinct positions and a geographical partial areas which together cover the large geographical area, and a method for the identification of a limited geographical area within a large geographical area, the large geographical area being divided in a geographical tree structure comprising geographical partial areas in ever-higher hierarchical levels, which together cover the large geographical area.

### TECHNICAL FIELD

The present invention relates to a gaming arrangement according to the preamble to claim 1 and a method for identification of a limited geographical area according to the preamble to claim 11.

### BACKGROUND ART

In a usual lottery game, a set of lottery tickets is distributed within a geographical area. For the draw, a random series of digits is usually generated, after which a winning lottery ticket can be identified. A common way of generating smaller prizes within the lottery is to use a part of the series of digits that represents the top prize in the lottery. Known systems use a reducing number of final digits to represent prizes of reducing size. In addition, there is no geographical representation based on the digits in the drawn series and on the position of the digits.

### BRIEF DESCRIPTION OF THE INVENTION

The object of the invention is to provide a gaming arrangement in which during the draw an ever-decreasing geographical area representing the lottery's top prize can be identified progressively. This object is achieved by a gaming arrangement according to the characterizing part of claim 1 and by a method for identification of a limited geographical area according to the characterizing part of claim 11. In a gaming arrangement comprising a set of lottery tickets divided according to a number series with a particular number of digits placed in the same number of distinct positions and a geographical tree structure for a large geographical area comprising geographical partial areas which together cover the large geographical area, it is ensured that a progressive identification of an increasingly limited geographical area is made possible by arranging each distinct position so that it corresponds to a hierarchical level in the said tree structure. A geographical tree structure constitutes a representation of an area, with the area being divided into partial areas. A partial area belongs to a different hierarchical level than the basic area that is made up of these partial areas. The tree structure constitutes a database which Is preferably stored and managed by a computer-based database host.

In a preferred embodiment of the invention, the gaming arrangement comprises a communication medium arranged to transmit randomly selected digits, with the said communication medium being arranged to present the said digits in an order that corresponds to the increasing number of levels in the geographical tree structure. By arranging In the gaming arrangement a communication medium that presents randomly selected digits in an order that corresponds to an increasing number of levels in the geographical tree structure, a progressive identification of an increasingly limited area is obtained and this identification is communicated at the same time. In an additional preferred embodiment of the invention, the gaming arrangement comprises a random generator arranged to generate randomly selected digits, a communication medium and a visual representation of the large geographical area divided according to the said tree structure, the communication medium being arranged to transmit a visual representation corresponding to the geographical subordinate level that was on this occasion identified by the randomly selected digits. This embodiment of the invention makes possible a simple and comprehensible representation of the identified area.

### DESCRIPTION OF DRAWINGS

The invention will be described in greater detail with reference to the attached drawings in which

FIG. 1 shows a lottery ticket in the said set of lottery tickets,

FIG. 2 shows a large geographical area,

FIG. 3 shows a geographical partial area corresponding to the first subordinate level of the hierarchy,

FIG. 4 shows a geographical partial area corresponding to the second subordinate level of the hierarchy,

FIG. 5 shows a geographical partial area corresponding to the third subordinate level of the hierarchy,

FIG. 6 shows a geographical partial area corresponding to the fourth subordinate level of the hierarchy,

FIG. 7 shows a geographical partial area corresponding to the fifth subordinate level of the hierarchy, and

FIG. 8 shows a gaming arrangement

### MODES FOR CARRYING OUT THE INVENTION

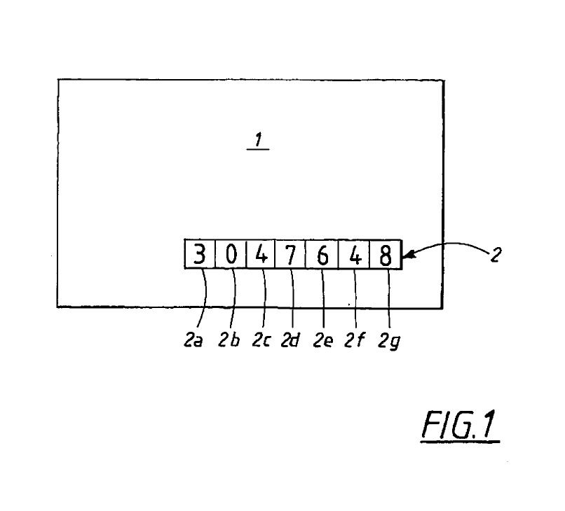

FIG. 1 shows a lottery ticket 1 in a set of lottery tickets. The lottery ticket has a number 2 in a number series with a particular number of digits. In the embodiment shown, the number series comprises seven digits, each placed in a position 2a- 2f , which permits a maximal number of 9,999,999 lottery tickets. The positions correspond in the normal way to units, tens, hundreds, thousands, etc. Of course, more or fewer positions can be used. In a preferred embodiment of the invention, the number series comprises at least four positions. Each of the positions 2a- 2g corresponds to a hierarchical level In a tree structure for a large geographical area, in which the partial areas of the geographical structure together cover the large geographical area. By each of the positions 2a- 2g corresponding to a hierarchical level in the tree structure, is meant that the first position corresponds to a first hierarchical level, the second position corresponds to a second hierarchical level, and so on.

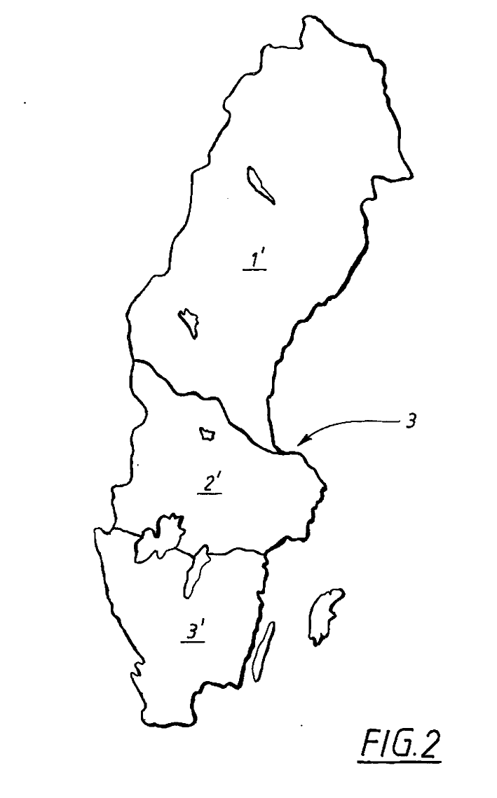

FIG. 2 shows a large geographical area 3 which, in a preferred embodiment of the invention, corresponds to a country, which in the embodiment shown consists of Sweden. In addition, it shows the division of the large geographical area 3 into three geographical partial areas 1′, 2′, 3′ corresponding to the first subordinate level of the hierarchy 4. Position 2a in the number series on the lottery ticket in FIG. 1 indicates that the area 3′ in the first subordinate level of the hierarchy is selected to win. In a preferred embodiment of the invention, the second subordinate level of the hierarchy 5 consists of regions. In the example shown, the position 2a can assume any one of the values 1, 2 or 3.

FIG. 3 shows the geographical partial area 3′ corresponding to the first subordinate level of the hierarchy 4 that was selected according to the first position 2a in the number series 2 on the lottery ticket The geographical partial area 3′ corresponding to the first subordinate level of the hierarchy 4 is further divided into geographical partial areas 0″- 9″ corresponding to the second subordinate level of the hierarchy 5. Position 2b In the number series on the lottery ticket in FIG. 1 indicates that the area 0″ in the second subordinate level of the hierarchy has been selected.

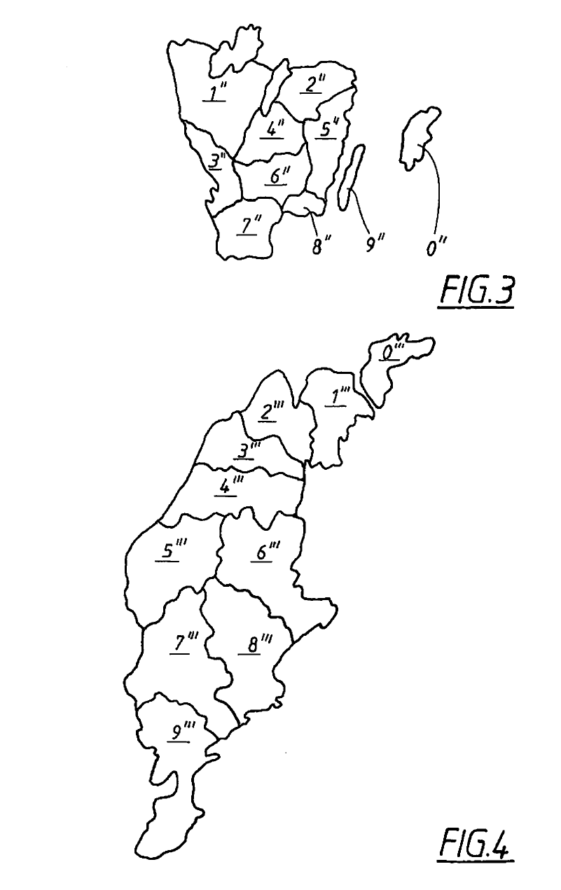

FIG. 4 thus shows a geographical partial area corresponding to the second subordinate level of the hierarchy 5 that was selected according to the second position 2b in the number series 2 on the lottery ticket. In the embodiment shown, Gotland is shown, comprising geographical partial areas 0″′- 9″′ corresponding to the third subordinate level of the hierarchy. The position 2c in the number series on the lottery ticket in FIG. 1 indicates that the area 4′″ in the third subordinate level of the hierarchy has been selected. In a preferred embodiment of the invention, the second subordinate level of the hierarchy 5 consists of counties.

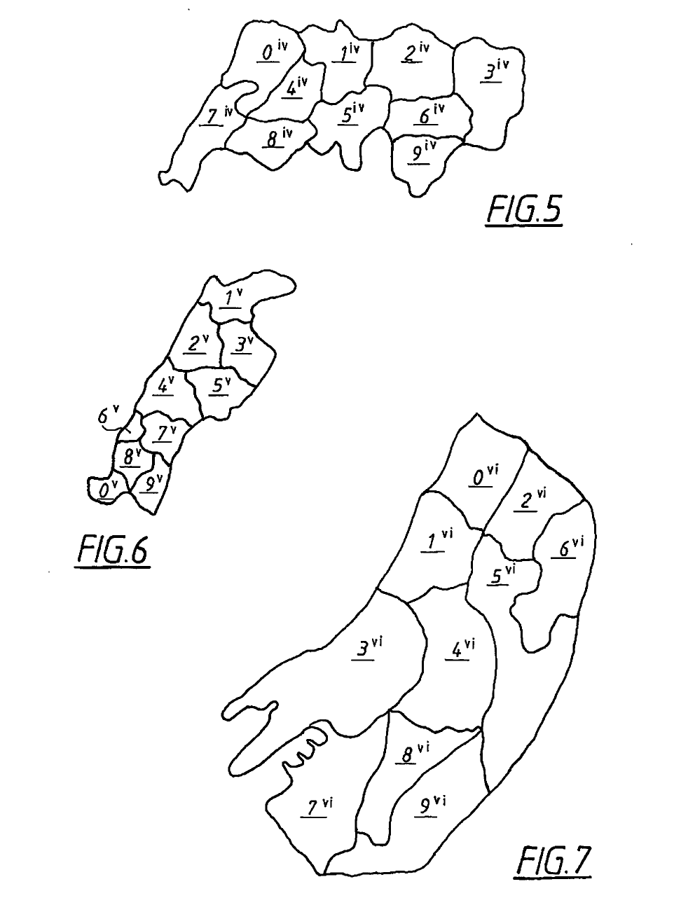

FIG. 5 thus shows a geographical partial area corresponding to the third subordinate level of the hierarchy that was selected according to the second position 2c in the number series 2 on the lottery ticket. In the embodiment shown, a part of Gotland is shown, comprising geographical partial areas 0^{lv}-9^{lv} corresponding to the fourth subordinate level of the hierarchy. The position 2d in the number series on the lottery ticket in FIG. 1 indicates that the area 7^{v} in the fourth subordinate level of the hierarchy has been selected. In a preferred embodiment of the invention, the third subordinate level of the hierarchy consists of districts.

FIG. 6 thus shows a geographical partial area corresponding to the fourth subordinate level of the hierarchy that was selected according to the second position 2d in the number series 2 on the lottery ticket. In the embodiment shown, a parish of Visby is shown, comprising geographical partial areas 0^{v}-9^{v} corresponding to the fifth subordinate level of the hierarchy. The position 2e in the number series on the lottery ticket in FIG. 1 indicates that the area 6^{v} in the fifth subordinate level of the hierarchy has been selected.

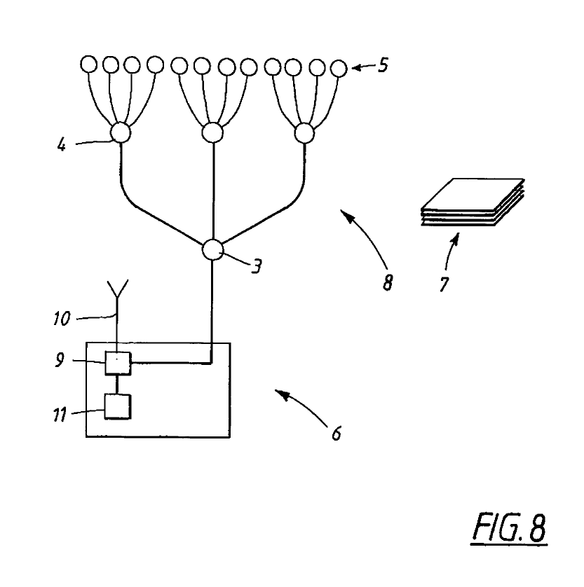

FIG. 7 thus shows a geographical partial area corresponding to the fifth subordinate level of the hierarchy that was selected according to the second position 2e in the number series 2 on the lottery ticket. In the embodiment shown, the town of Visby is shown, comprising geographical partial areas 0^{vl}-9^{vl} corresponding to the sixth subordinate level of the hierarchy. The position 2f in the number series on the lottery ticket in FIG. 1 indicates that the area 4^{vl} in the sixth subordinate level of the hierarchy has been selected. In a preferred embodiment of the invention, the lowest subordinate level of the hierarchy 5 consists of the point of sale with a surrounding catchment area. By the lowest subordinate level of the hierarchy is meant the level at which the geographical area is the most finely divided.

Position 2g thus consists of one of ten possible lottery tickets that are associated with the area 4^{vl} in the sixth subordinate level of the hierarchy.

FIG. 8 shows a gaming arrangement 6 comprising a set of lottery tickets 6 in accordance with what has been described above. The gaming arrangement also comprises a geographical tree structure 8 comprising a representation of a large geographical area 3 with geographical partial areas 4, 5. The geographical partial areas are divided into hierarchical levels. In a preferred embodiment of the invention, there are at least three subordinate levels of the hierarchy, preferably at least five. In accordance with what has been described above, the geographical partial areas cover the large geographical area. In addition, the gaming arrangement 6 comprises a communication medium 9 in the form of a transmission unit 10. According to an embodiment, the gaming arrangement 6 comprises a random generator 11 for generating drawn digits with the draw being carried out in a sequence that corresponds to ever-higher levels of the hierarchy. By this means, a progressive identification of a winning geographical area can be carried out. The communication medium 9 also receives information about which area is currently selected and, according to a preferred embodiment, generates a visual representation of the corresponding geographical partial area. The geographical tree structure can also be stored in the communication medium in the form of a database. According to an embodiment, this is carried out by the geographical tree structure storing map images of the corresponding geographical subordinate level in a memory and by these images being transmitted via the transmitter unit 10 to a receiving unit

For the identification of which area has been selected, a method is thus used for the identification of a limited geographical area within a large geographical area, the large geographical area being divided in a geographical tree structure comprising geographical partial areas In ever-higher hierarchical levels, which together cover the large geographical area, characterized in that the method comprises a successive random draw of numbers in a number series with a particular number of digits where each position in the number series corresponds to a subordinate level of the hierarchy, making possible a progressive identification of an increasingly limited area within the large geographical area.

According to a preferred embodiment of the invention, a visual representation of the increasingly limited geographical area is transmitted via a communication channel. The communication channel is of a known type and comprises among other things a TV camera connected to a ground-based, satellite or cable-based TV network, or alternatively of a computer-based network.

The invention is not limited to the embodiments described above, but can be varied freely within the framework of the following patent claims.

1. Gaming arrangement (6) comprising a set of lottery tickets (7) divided according to a number series with a particular number of digits placed in the same number of distinct positions and a geographical tree structure (8) for a large geographical area (3) comprising geographical partial areas (4, 5) which together cover the large geographical area (3), characterized in that each distinct position corresponds to a hierarchical level in the said tree structure.

2. Gaming arrangement as claimed in claim 1, characterized in that the number series comprises at least four positions.

3. Gaming arrangement as claimed in any one of the preceding claims, characterized in that the large geographical area corresponds to a country.

4. Gaming arrangement as claimed in claim 3, characterized in that the first subordinate level of the hierarchy corresponds to a number of identifiable regions, which number is less than ten.

5. Gaming arrangement as claimed in claim 4, characterized in that the second subordinate level of the hierarchy corresponds to counties.

6. Gaming arrangement as claimed in claim 5, characterized in that the third subordinate level of the hierarchy corresponds to districts.

7. Gaming arrangement as claimed in claim 6, characterized in that the fourth subordinate level of the hierarchy corresponds to a number of identifiable parts of districts, which number is less than ten.

8. Gaming arrangement as claimed in claim 7, characterized in that the highest subordinate level of the hierarchy corresponds to a point of sale.

9. Gaming arrangement as claimed in any one of the preceding claims, which gaming arrangement comprises a communication medium (9) arranged to transmit randomly selected digits, characterized in that the said communication medium (9) is arranged to present the said digits in an order that corresponds to the increasing number of levels in the geographical tree structure.

10. Gaming arrangement as claimed in any one of the preceding claims, which gaming arrangement comprises a random generator (11) arranged to generate randomly selected digits and a communication medium (9), characterized in that the gaming arrangement comprises a visual representation of the large geographical area divided according to the said tree structure and which said communication medium is arranged to transmit a visual representation corresponding to the geographical subordinate level that was on this occasion identified by the randomly selected digits.

11. Method for identification of a limited geographical area within a large geographical area (3), the large geographical area (3) being divided in a geographical tree structure (8) comprising geographical partial areas (4, 5) in ever-higher hierarchical levels, which together cover the large geographical area (3), characterized In that the method comprises a successive random draw of numbers in a number series with a particular number of digits where each position in the number series corresponds to a subordinate level of the hierarchy (4, 5) making possible a progressive identification of an increasingly limited area within the large geographical area.

12. Method as claimed in claim 11, characterized in that a visual representation of the increasingly limited geographical area is transmitted via a communication channel.
